(19) United States
(12) Patent Application Publication
(10) Pub. No.: US 2009/0294276 A1
(43) Pub. Date: Dec. 3, 2009

(54) METHOD AND APPARATUS OF FORMING DOMAIN INVERSION STRUCTURES IN A NONLINEAR FERROELECTRIC SUBSTRATE

(76) Inventors: Chang Qing Xu, Hamilton (CA); Jen-Shih Chang, Hamilton (CA); Jonathan Markle, Puslinch (CA)

Correspondence Address: Russ Weinzimmer, 614 Nashua Street, Suite 53, Milford, NH, 03055, US

(21) Appl. No.: 12/442,523

(22) PCT Filed: Sep. 20, 2007
(86) PCT No.: PCT/CA2007/001681

§ 371 Date: Mar. 23, 2009

Related U.S. Application Data
(60) Provisional application No. 60/847,122, filed on Sep. 26, 2006.

(51) Int. Cl. H05H 1/00; B01J 19/08

(52) U.S. Cl. 204/164; 422/186.04

(57) ABSTRACT

A crystal poling apparatus has as ingle-domain ferroelectric substrate (e.g. MgO doped LiNbO3 substrate), a sample holder, a high voltage source, a corona torch, a gas source, a chamber, and at least one vacuum pump. An electrode with a certain structure (e.g. a periodical pattern) is formed on the first surface of the substrate, and the substrate is set with the electrode facing down on top of the sample holder. The electrode is grounded so that high electric field is formed in the area with electrode due to the formation of charges generated by the corona torch on the second surface of the substrate. The charge distribution on the second surface of the substrate is controlled by the high voltage source and the gas source. To achieve the optimized crystal poling, the temperature of the substrate is set by the temperature controller, and the electrode on the first surface of the substrate is isolated by the vacuum pump.

### FIELD OF INVENTION

The present invention relates to forming a domain inversion structure in a ferroelectric substrate, which is required in nonlinear optical devices based on the quasi-phase matching (QPM) technique and other photonic devices.

### BACKGROUND OF THE INVENTION

Reversing domain of ferroelectric materials is a key technology in developing optical nonlinear devices such as wavelength converters. One example of the wavelength converters is disclosed in the literature “J. A. Armstrong et al., Physical Review, vol. 127, No. 6, Sep. 15, 1962, pp. 1918-1939; C. Q. Xu, et al., Appl. Phys. Lett., Vol. 63, 1993, pp. 3559-3561; and K. Gallo, et al., Appl. Phys. Lett., vol. 71, 1997, pp. 1020-1022”. In this literature, the wavelength conversion device employs a wavelength conversion element having a waveguide in which a periodical domain inversion grating is formed in the waveguide direction so as to satisfy the quasi-phase matching (QPM) condition. By inputting pump light of an angular frequency of ωₚ and signal light of an angular frequency ωₛ into the wavelength conversion element, wavelength conversion is achieved so as to obtain converted light of an angular frequency ω_{c}. If pump light with higher angular frequency is used, the converted angular frequency ω_{c} is given by ω_{c}=ωₚ−ωₛ (i.e., difference frequency generation (DFG)), otherwise the converted angular frequency ω_{c} is given by ω_{c}=2ₚ−ωₛ (i.e., cascaded second-order nonlinear interaction). Another example of the wavelength converters is disclosed in the literature “J. A. Armstrong et al., Physical Review, vol. 127, No. 6, Sep. 15, 1962, pp. 1918-1939; M. Yamada, et al., Applied Physics Letters, vol. 62, no. 5, 1993, pp. 435-436”. In this literature, the wavelength conversion device employs only a periodical domain inversion grating to satisfy the quasiphase matching condition. By inputting pump light of an angular frequency of ω_{f} into the wavelength conversion element, the wavelength conversion is achieved so as to obtain converted light of an angular frequency 2ω_{f}, i.e., second-harmonic generation (SHG)).

To achieve efficient wavelength conversion, highly uniform periodically domain inverted structures are required. One method to form the periodically domain inverted structure is disclosed in the literature “Akinori Harada, U.S. Pat. No. 5,594,746; Akinori Harada, U.S. Pat. No. 5,568,308; A. Harada, et al., Applied Physics Letters, vol. 69, no. 18, 1996, pp. 2629-2631”, as shown in FIG. 1. In this literature, a corona wire 3 and grounding shield 4 are positioned above the −c surface of a MgO doped lithium niobate single crystal substrate 1 with a periodical electrode pattern 2 on +c surface of the substrate. The electrode is grounded. If the corona wire is supplied with a high voltage provided by a high voltage source 5, corona discharge is initiated, resulting in negative charges on −c surface of the substrate. Due to the existence of the charges on −c surface, a voltage potential difference is created, generating a strong electric field across the substrate. If the generated electric field is larger than the internal electric field (i.e. coerceive field) of the crystal, domains under the electrode are inverted since the direction of the generated electric field is opposite to the internal field of the crystal. Since the coerceive field decreases with the increase of temperature, a temperature controller 6 is employed in the literature to reduce the electric field required for domain inversion. To increase electrical discrimination between the periodical electrode patterns, a vacuum pump 7 is used.

The reported domain inversion method can only pole a crystal in a narrow region along the direction of the wire due to the usage of the corona wire. It is desirable to achieve uniform domain inversion over the entire area of a full wafer (e.g. 3″ circular wafer).

Another method which could be used to form the periodically domain inverted structures is disclosed in the literature “Fang, U.S. Pat. No. 5,045,364, Soane, et al., U.S. Pat. No. 5,026,147”, as shown in FIG. 2. In this literature, a needle 3 is positioned above one surface of a polymer film 21 with an electrode pattern 22 on another surface of the polymer film. The film is formed on a substrate 24. The electrode is grounded. If the needle is supplied with a high voltage provided by a high voltage source 5, corona discharge charges the top surface of the polymer. Due to the existence of the charges on the top surface, a voltage potential difference is created, generating a strong electric field across the polymer film. If the generated electric field is adequate the polymer molecules under the electrode are aligned along the electric field. The polymer's dipole orientation will remain relatively unchanged unless it is heated. Therefore, the poling process involves heating the sample, applying the poling field, and cooling the sample allowing the polymer's dipoles to solidify while aligned. A temperature controller 6 is required for polymer poling in the literature.

The reported domain inversion method can only pole a crystal in a small region directly beneath the needle. It is desirable to achieve uniform poling over the entire area of a full wafer (e.g. 3″ circular wafer). A drawback of the reported method is the high risk of transition to spark discharge or ion beam formation which will damage the substrate or result in non-uniform poling.

### SUMMARY OF THE INVENTION

The objective of the present invention is to provide an improved domain inversion method with simplified configuration and capability of large area poling.

The present invention provides a method for ferroelectric domain inversin, in which a corona touch positioned above one surface of a substrate and an electrode on opposite surface of the substrate are employed to create the necessary electric field to reverse polarization of the ferroelectric crystal.

The present invention also provides crystal poling apparatus comprising:

a corona torch which is positioned above one surface of a ferroelectric substrate;

a high voltage (DC,AC or RF) power source which is connected with corona torch to generate corona discharge;

a ferroelectric crystal substrate with a periodical electrode pattern on one surface of the substrate;

a sample holder on which the substrate is set and the electrode pattern of the substrate is faced;

a means to increase electrical discrimination of the electrode pattern;

a means to control temperature of the substrate; and

a gas source to provide the necessary environment required for corona discharge.

### DESCRIPTION OF THE DRAWINGS

Embodiments of the invention will now be described, by way of example, with reference to the accompanying drawings in which:

FIG. 1 is a schematic drawing of a prior art of crystal poling apparatus based on the corona wire discharge method,

FIG. 2 is a schematic drawing of a prior art of polymer poling apparatus based on the needle discharge method,

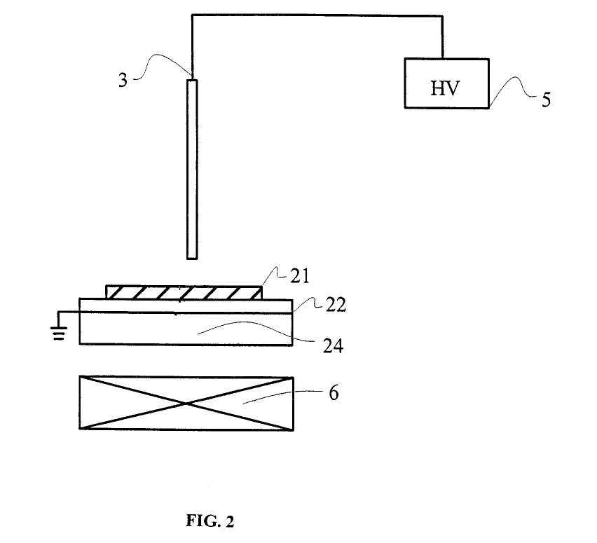

FIG. 3 is a schematic diagram for explaining crystal poling apparatus according to the present invention,

FIG. 4 is a schematic diagram for explaining the first preferred embodiment of the structure of the corona torch according to the present invention,

FIG. 5 is a schematic diagram for explaining the second preferred embodiment of various configuration of a corona torch array according to the present invention,

FIG. 6 is a schematic diagram for explaining the third preferred embodiment of a modified corona torch array according to the present invention,

FIG. 7 is a schematic diagram for explaining the fourth preferred embodiment of a combination of corona torch and corona wire according to the present invention,

FIG. 8 is a schematic diagram for explaining the fifth preferred embodiment of a corona wire array according to the present invention,

FIG. 9 is a schematic diagram for explaining the sixth preferred embodiment of a modified gas flow unit according to the present invention,

FIG. 10 is a structural diagram for explaining the seventh preferred embodiment of a modified electrode according to the present invention.

### DESCRIPTION OF PREFERRED EMBODIMENTS

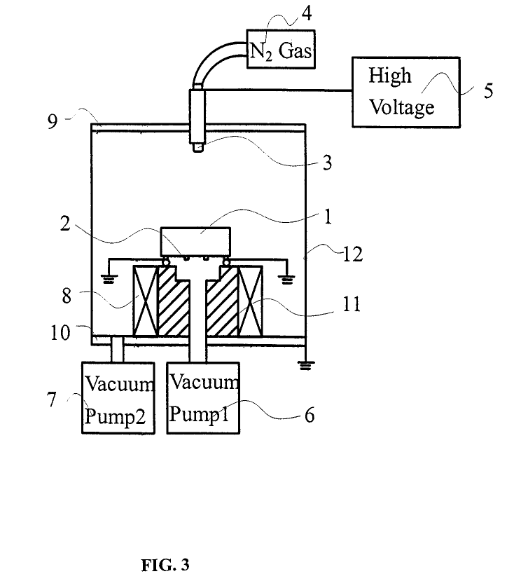

In the first preferred embodiment, as shown in FIG. 3, a preferred crystal poling apparatus comprises of a corona torch 3, positioned above the −c surface of a ferroelectric single crystal with a power source 5. The substrate 1 with a periodical electrode pattern 2 on +c surface of the substrate is grounded. The ferroelectric substrate is set on a sample holder 11, which is connected with a vacuum pump 6 and a temperature controller 8. The vacuum level can be set between 10⁻⁶ torr and 1 atmosphere and the temperature can range between room temperature and 200° C. The whole system may be included in a chamber 12 with a top-cover 9 and a bottom cover 10, and may be connected with the second vacuum pump 7. The vacuum level of the second vacuum pump can be set between 10⁻³ torr and 1 atmosphere. The corona torch 3 is connected with a high voltage source 5, and supplied with N₂ gas through a gas source 4. The voltage from the power supplier 5 is set at a value between 1 kV and 100 kV (e.g. 10 kV) to achieve the electric field strength required to pole the crystal. The N₂ gas flow rate can be a value between 0 and 100 l/min. (e.g. 5 l/min.).

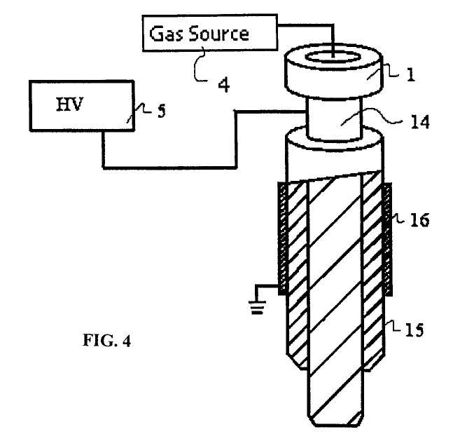

The corona torch employed in the crystal poling apparatus shown in FIG. 3 is shown in FIG. 4. The corona torch is formed from two metal tubes with the same inner diameter. The inner diameter of the metal tubes can be a value between 0.1 mm and 10 mm (e.g. 1 mm). The outer diameter of the two metal tubes can be a value between 1 mm and 1000 mm (e.g. 10 mm for the first cylinder 1 and 2 mm for the second cylinder 14). The length of the two metal tubes can be a value between 1 mm and 1000 mm (e.g. 50 mm for the first metal tube 1 and 50 mm for the second metal tube 14). The two metal tubes are protected by a tube 15 made of an electrically insulating material (e.g. Teflon) and are connected with the power source 5 and gas source 4. A second electrode 16 formed on the outlet surface of the insulating tube 15 is grounded.

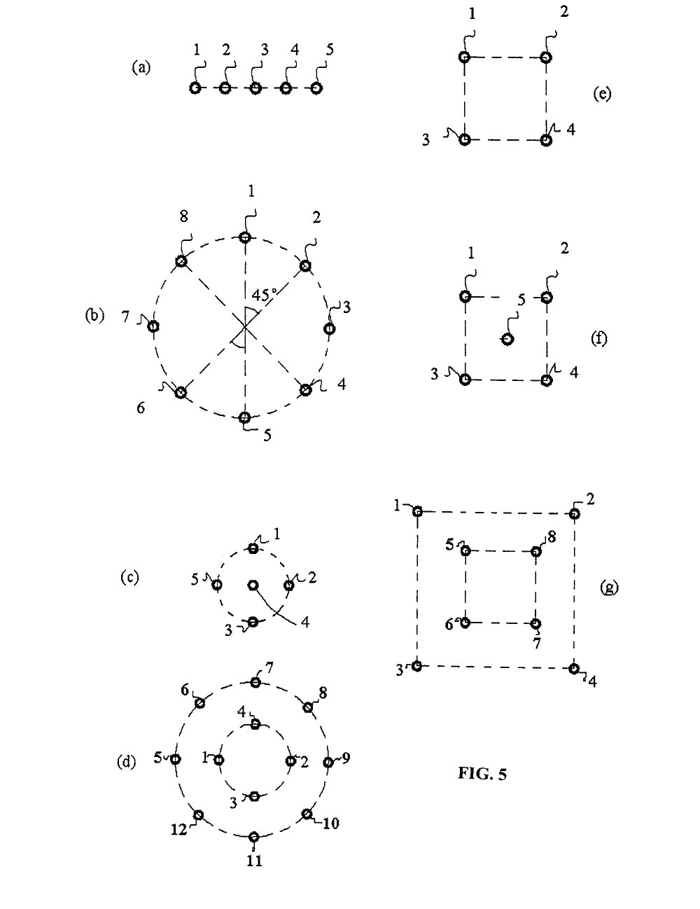

In the second preferred embodiment of the present invention, alternative corona torch with an array configuration employed in the crystal poling apparatus shown in FIG. 3, is shown in FIG. 5. In FIG. 5(a), a number of torches (e.g. 5 torches) are arranged along a line with certain interval (e.g. 10 mm). Each torch can be either connected with the same high voltage source or different high voltage sources independent with each other. Compared with the single torch configuration shown FIG. 3, the configuration shown in FIG. 5(a) is effective in poling rectangular shaped larger area crystal. In FIG. 5(b), a number of torches (e.g. 8 torches) are arranged on a circle with certain angular interval (e.g. 45°). The radius of the circle can be a value between 1 mm and 100 mm (e.g. 10 mm). Each torch can be either connected with the same high voltage source or different high voltage sources independent with each other. Compared with the single torch configuration shown FIG. 3, the configuration shown in FIG. 5(b) is effective in poling circular shaped larger area crystal since uniform charge distribution can be achieved over the entire −c surface of the substrate by employing this configuration. In FIG. 5(c), a number of torches (e.g. 4 torches) are arranged on a circle with certain angular interval (e.g. 90°), while additional torch is set at the center of the circle. The radius of the circle can be a value between 1 mm and 100 mm (e.g. 10 mm). Each torch can be either connected with the same high voltage source or different high voltage sources independent with each other. Compared with the single torch configuration shown FIG. 3, the configuration shown in FIG. 5(c) is effective in poling circular shaped larger area crystal since uniform charge distribution can be achieved over the entire −c surface of the substrate by employing this configuration. In FIG. 5(d), a number of torches (e.g. 12 torches) are arranged on two circles with certain angular interval (e.g. 45° on the first circle and 90° on the second circle). The radius of the circle can be a value between 1 mm and 100 mm (e.g. 10 mm for the first circle and 20 mm for the second circle). Each torch can be either connected with the same high voltage source or different high voltage sources independent with each other. Compared with the single torch configuration shown FIG. 3, the configuration shown in FIG. 5(d) is effective in poling circular shaped larger area crystal since uniform charge distribution can be achieved over the entire −c surface of the substrate by employing this configuration. In FIG. 5(e), a number of torches (e.g. 4 torches) are arranged at each corner of a square. The sides of the square can be a value between 1 mm and 100 mm (e.g. 10 mm). Each torch can be either connected with the same high voltage source or different high voltage sources independent with each other. Compared with the single torch configuration shown FIG. 3, the configuration shown in FIG. 5(e) is effective in poling square or circular shaped larger area crystal since uniform charge distribution can be achieved over the entire −c surface of the substrate by employing this configuration. In FIG. 5(f), a number of torches (e.g. 4 torches) are arranged at each corner of a square, while additional torch is set at the center of the square. The sides of the square can be a value between 1 mm and 100 mm (e.g. 10 mm). Each torch can be either connected with the same high voltage source or different high voltage sources independent with each other. Compared with the single torch configuration shown FIG. 3, the configuration shown in FIG. 5(f) is effective in poling square or circular shaped larger area crystal since uniform charge distribution can be achieved over the entire −c surface of the substrate by employing this configuration. In FIG. 5(g), a number of torches (e.g. 4 torches) are arranged at each corner of two squares. The sides of the squares can be a value between 1 mm and 100 mm (e.g. 10 mm for the first square and 20 mm for the second). Each torch can be either connected with the same high voltage source or different high voltage sources independent with each other. Compared with the single torch configuration shown FIG. 3, the configuration shown in FIG. 5(g) is effective in poling square or circular shaped larger area crystal since uniform charge distribution can be achieved over the entire −c surface of the substrate by employing this configuration.

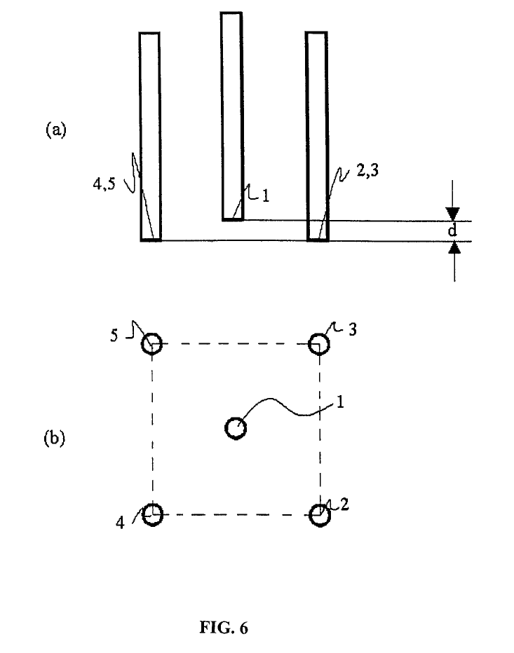

In the third preferred embodiment of the present invention, an alternative corona torch with an array configuration employed in the crystal poling apparatus shown in FIG. 3, is shown in FIG. 6. FIG. 6(a) and FIG. 6(b) show side view and top view of the configuration, respectively. In FIG. 6, a number of torches (e.g. 4 torches) are arranged at each corner of a square, while a torch is set at the center of the square. The sides of the square can be a value between 1 mm and 100 mm (e.g. 10 mm). The height difference d between the torches at the center of the square and the torches at the corners of the square can be a value between 1 mm and 10 mm (e.g. 5 mm). Each torch can be either connected with the same high voltage source or different high voltage sources independent with each other. Compared with the torch configuration shown in FIG. 5(f), the configuration shown in FIG. 6 can create more uniform charge distribution over the entire −c surface of the substrate by employing this configuration due to the following reasons. First, corona charge contributed from each torch has certain distribution. The charge density right under the torch is higher. As a result, positions near the center of the square usually have higher charge density. Second, the charge density is dependent on the height of the torch (i.e. the distance between the torch and −c surface of the substrate). The higher the corona torch, the lower surface charge density is. As a result, raising and lowering the height of the torch at the center of the square torch array can control the corona torch charging distribution.

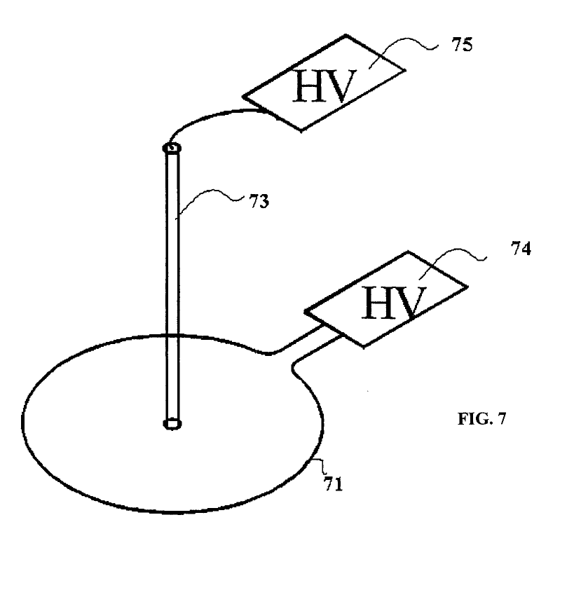

In the fourth preferred embodiment of the present invention, the corona torch employed in the crystal poling apparatus shown in FIG. 3 is shown in FIG. 7. In FIG. 7, a circular corona wire 71 is used, while the additional torch 73 is set at the center of the circle. The radius of the circle can be a value between 1 mm and 100 mm (e.g. 10 mm). The corona wire and torch can be either connected with the same high voltage source or different high voltage sources 74, 75 independent with each other. Compared with the single torch configuration shown FIG. 3, the configuration shown in FIG. 7 is effective in poling circular shaped larger area crystals since uniform charge distribution can be achieved over the entire −c surface of the substrate by employing this configuration.

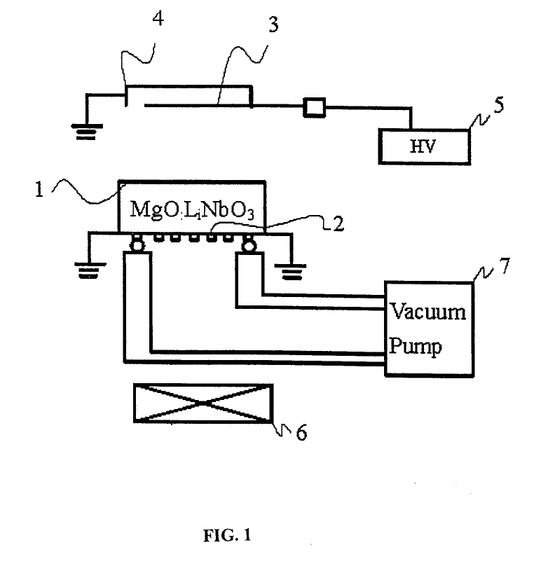

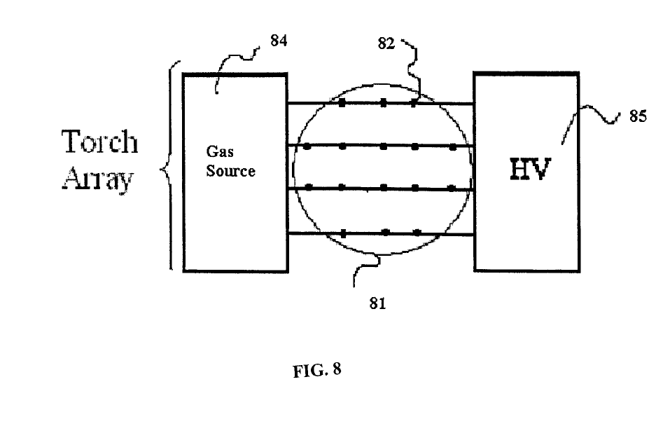

In the fifth preferred embodiment of the present invention, the corona torch as shown in FIG. 3 is employed in an array structure shown in FIG. 8. In FIG. 8, a corona torch array 82 is used. The charging array is positioned above the substrate 81. The interval of the array can be a value between 1 mm and 100 mm (e.g. 10 mm). The corona torches can be either connected with the same high voltage source 85 or different high voltage sources independent with each other. The corona torches can be either connected with the same gas source 84 or different gas sources independent with each other. Compared with the single torch configuration shown FIG. 3 or the single wire configuration in FIG. 1, the configurations shown in FIG. 8 are effective in poling larger area crystals since uniform charge distribution can be achieved over the entire −c surface of the substrate by employing this configuration. The array of corona torches can be replaced with an array of corona wires similar to FIG. 1.

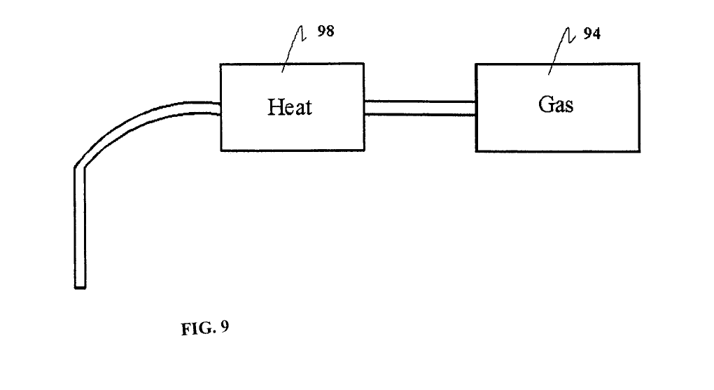

In the sixth preferred embodiment of the present invention, the gas flow source employed in the crystal poling apparatus shown in FIG. 3 is shown in FIG. 9. In FIG. 9, temperature of the gas (from the gas source 94) flowing into the corona torch is controlled by a heater 98. Compared with the gas flow unit shown FIG. 3, the configuration shown in FIG. 9 can reduce the stress caused by the temperature difference between the gas and substrate, and thus prevent any damage of the substrate during the poling process.

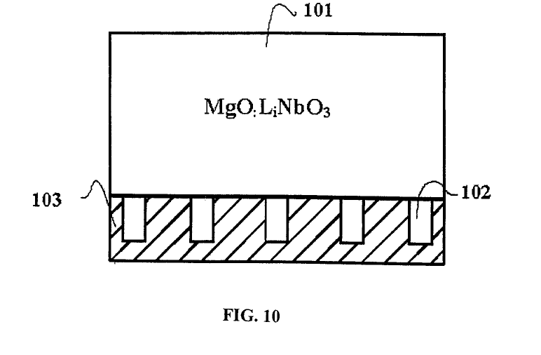

In the seventh preferred embodiment of the present invention, the sample holder employed in the crystal poling apparatus shown in FIG. 3 is shown in FIG. 10. In FIG. 10, electric isolation of the electrode pattern is achieved by employing a SiO₂ film 103 on top of the electrode 102, which is formed on the substrate 101. As a result, it is not necessary to connect the sample holder with a high vacuum pump. Compared with the sample holder shown FIG. 3, the configuration shown in FIG. 10 can simplify the sample holder, and thus reduce manufacture cost.

The above embodiments have described crystal poling of MgO doped lithium niobate. Of course, the methods described in the present invention can be applied to other ferroelectric materials such as LiTaO₃, KTP, etc.

The above embodiments have included a number of different configurations for corona torch and corona wire. Of course, different combinations of the described configuration can also achieve large area crystal poling. These configurations can be combined in a numerous different ways with those explicitly described in the present patent.

The above embodiments have described the heating unit attached with the sample holder. Of course, other heating units such as IR heater can also provide the similar effect of increasing the temperature of the substrate.

The above embodiments have described the electric isolation layer (i.e. SiO₂). Of course, other insulators such as photo-resistor can also provide the similar effect of increasing electrical discrimination of the electrode pattern.

The above embodiments have described the flow gas (i.e. N₂). Of course, other noble gases such as Ar can also provide the similar effect of generating corona discharges.

The above embodiments have described the second vacuum pump connected with the chamber to remove the unnecessary air from the chamber. Of course, other methods to purge the gas in the chamber can also provide the similar effect of removing the unnecessary air from the chamber.

Other embodiments of the invention will now be readily apparent to a person skilled in the art, the scope of the invention being defined in the appended claims.

1. A method for ferroelectric domain inversion, in which a corona torch positioned above one surface of a substrate and an electrode on an opposite surface of the substrate are employed to create the necessary electric field to reverse polarization of the ferroelectric crystal.

2. A crystal poling apparatus, comprising:
a corona torch which is positioned above one surface of a ferroelectric substrate;
a high voltage (DC, AC or RF) power source which is connected with the corona torch to generate corona discharge;
a ferroelectric crystal substrate with a periodical electrode pattern on one surface of the substrate;
a sample holder on which the substrate is set and the electrode pattern of the substrate is faced; a means to increase electrical discrimination of the electrode pattern;
a means to control temperature of the substrate; and
a gas source to provide the necessary environment required for corona discharge.

3. The electrode pattern of claim 2, being grounded; and formed on +c surface of the ferroelectric substrate.

4. The means to increase electrical discrimination of the electrode pattern of claim 2, comprising: a vacuum pump; and a connector which connects substrate and the vacuum pump.

5. The means to increase isolation of the electrode pattern of claim 2, comprising an electrically insulating film on top of the electrode pattern.

6. The crystal poling apparatus of claim 2, components as said the corona torch, sample holder, and substrate are contained in a chamber.

7. The means to control temperature of the substrate of claim 2, comprising: a heater connected with the sample holder; a temperature sensor positioned close to the substrate; and a feedback circuit to stabilize temperature of the substrate.

8. The means to control temperature of the substrate of claim 2, comprising: a radiation heather set aside the sample holder; a temperature sensor positioned close to the substrate; and a feedback circuit to stabilize temperature of the substrate.

9. The corona torch of claim 2, comprising multiple torches which are arranged in certain configuration with certain distance.

10. The multiple corona torches of claim 9, in which the torches are connected with a single power source.

11. The multiple corona torches of claim 9, in which each torch is connected with an individual power source, respectively.

12. The multiple corona torches of claim 9, in which the torches are arranged along a line.

13. The multiple corona torches of claim 9, in which the torches are arranged along at least one closed curve, each closed curve being symmetric about a respective central point, the at least one closed curve being one of:
a circle;
a plurality of circles;
a square, in which the torches are arranged at the corners of the square; and
a rectangle, in which the torches are arranged at the corners of the rectangle.

14. (canceled)

15. The multiple corona torches of claim 13 in which an additional torch is set at each of the respective central points of the at least one closed curve.

16. The multiple corona torches of claim 13, in which the torches are set at different heights.

17. The multiple corona torches of claim 15, in which the torches set at each respective central point of the at least one closed curve are set at different heights from other torches.

18. The gas supplier of claim 2, comprising: a gas tank; gas flow controller; and a gas temperature controller.

19. The gas tank of claim 18, containing one of nitrogen N₂ and a noble gas.

20. (canceled)

21. The multiple corona torches of claim 15, in which the torches are set at different heights.

22. A crystal poling apparatus comprising:
at least one curved corona wire Positioned above one surface of a ferroelectric substrate, the at least one curved corona wire being arranged in one of a circle, a plurality of circles, a square, and a rectangle;
a high voltage (DC, AC or RF) power source which is connected with the curved corona wire to generate corona discharge;
a ferroelectric crystal substrate with a Periodical electrode pattern on one surface of the substrate;
a sample holder on which the substrate is set and the electrode Pattern of the substrate is faced; a means to increase electrical discrimination of the electrode pattern;
a means to control temperature of the substrate; and a gas source to provide the necessary environment required for corona discharge.
